(19) United States
(12) Patent Application Publication
(10) Pub. No.: US 2025/0350482 A1
(43) Pub. Date: Nov. 13, 2025

(54) METHOD FOR EXECUTING BRIDGE PROTOCOLS FOR INTEROPERABLE BLOCKCHAIN NETWORKS

(71) Applicant: Chia Network Inc., San Francisco, CA (US)

(72) Inventors: Mihai Dancaescu, Bucuresti (RO); Bram Cohen, San Francisco, CA (US); Matthew Howard, San Francisco, CA (US); Cameron Cooper, Lakeview, TX (US)

(21) Appl. No.: 19/201,693

(22) Filed: May 7, 2025

Related U.S. Application Data
(60) Provisional application No. 63/643,840, filed on May 7, 2024.
(60) Provisional application No. 63/728,577, filed on Dec. 5, 2024.

(51) Int. Cl. H04L 9/00; G06Q 20/38; G06Q 20/40; H04L 9/32

(52) U.S. Cl. CPC H04L 9/50; G06Q 20/3825; G06Q 20/3827; G06Q 20/401; H04L 9/3213; H04L 9/3247

(57) ABSTRACT

A method for communicating data between a first blockchain and a second blockchain includes: accessing a message identifier for a message associated with the second blockchain; accessing signatures representing detection of the message, containing a representation of the message identifier, in a block in the second blockchain by validator nodes for the first blockchain; generating a transaction including the signatures and configured to trigger a portal object to generate a message object, associated with the first blockchain, representing the message in response to detecting the signatures; and transmitting the transaction to a distributed network associated with the first blockchain for commitment in a block in the first blockchain.

### CROSS-REFERENCE TO RELATED APPLICATIONS

This Application claims the benefit of U.S. Provisional Application No. 63/728,577, filed on 05-DEC.-2024, and U.S. Provisional Application No. 63/643,840, filed on 07-MAY-2024, each of which is incorporated in its entirety by this reference.

This Application is related to U.S. patent application Ser. No. 18/107,430, filed on 08-FEB.-2023, U.S. patent application Ser. No. 17/966,226, filed on 14-OCT.-2022, and U.S. patent application Ser. No. 17/966,214, filed on 14-OCT.-2022, each of which is incorporated in its entirety by this reference.

### TECHNICAL FIELD

This invention relates generally to the field of blockchain protocols and, more specifically, to a new and useful method for executing bridge protocols for interoperable blockchain networks within the field of blockchain protocols.

### BRIEF DESCRIPTION OF THE FIGURES

FIGS. 1A, 1B, and 1C are flowchart representations of a method; and

FIGS. 2A and 2B are flowchart representations of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

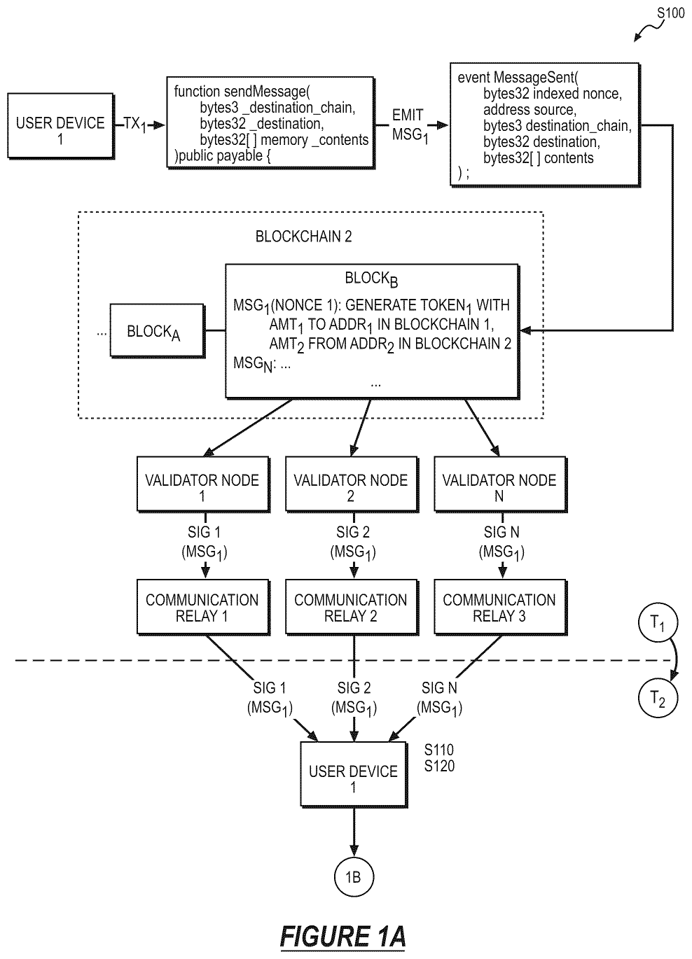

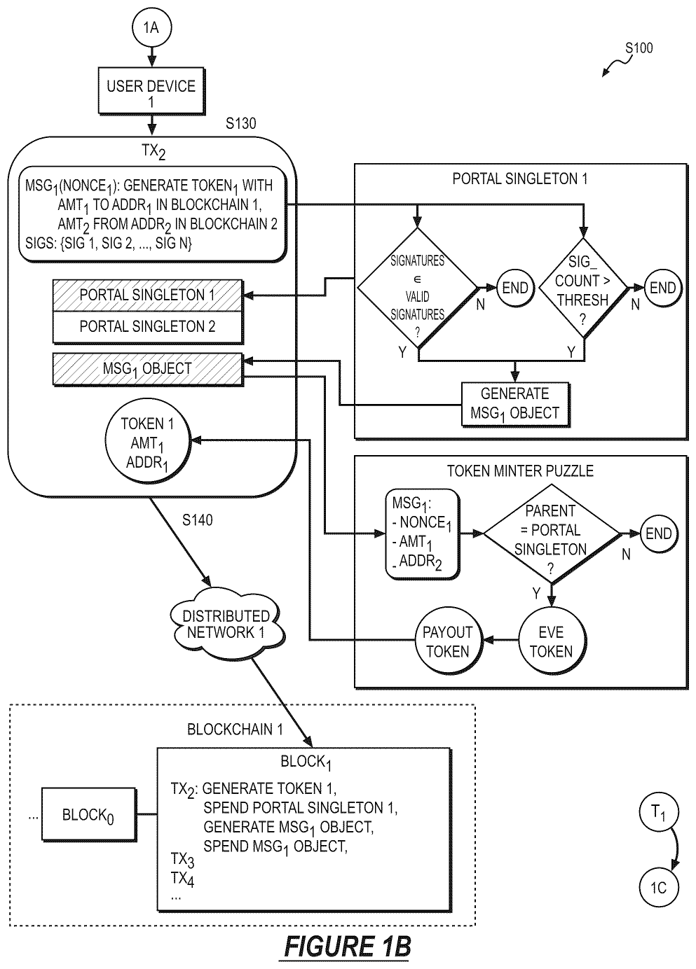

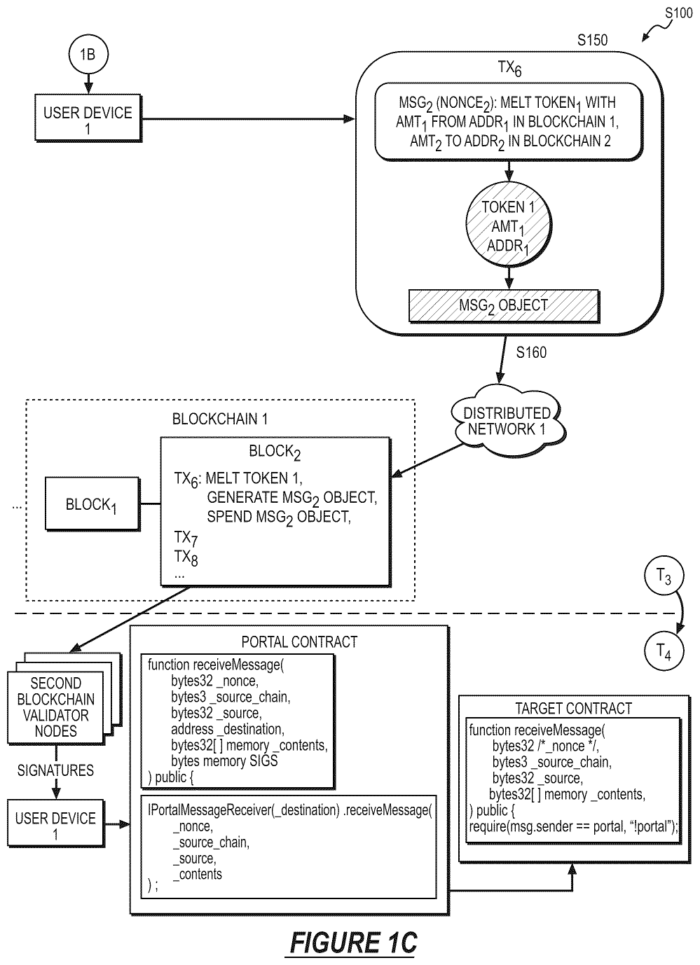

As shown in FIGS. 1A and 1B, a method S100 for communicating data between a first blockchain and a second blockchain includes, at a node: accessing a first message identifier for a first message associated with the second blockchain in Step S110; and accessing a set of signatures representing detection of the first message in a first block in the second blockchain by validator nodes in a set of validator nodes for the first blockchain in Step S120. The first message contains a representation of the first message identifier.

The method S100 also includes, in Step S130, generating a first transaction including the set of signatures and configured to: in response to detecting the set of signatures, trigger a first portal object to generate a first message object, in a set of blockchain objects associated with the first blockchain, representing the first message; remove the first portal object from the set of blockchain objects; and generate a second portal object, in the set of blockchain objects, based on the first portal object.

The method S100 further includes transmitting the first transaction to a distributed network associated with the first blockchain for commitment in a second block in the first blockchain in Step S140.

### 1.1 Variation: First Bridge Protocol

As shown in FIGS. 1A and 1B, one variation of the method S100 for communicating data between a first blockchain and a second blockchain includes: accessing a message identifier for a message associated with the second blockchain, the message representing generation of a token object associated with the first blockchain in Step S110; and accessing a set of signatures representing detection of the message in a first block in the second blockchain by validator nodes in a set of validator nodes for the first blockchain in Step S120. The message contains a representation of the message identifier.

This variation of the method S100 also includes, in Step S130, generating a first transaction including the set of signatures and configured to: in response to detecting the set of signatures, trigger a first portal object to generate a message object, in a set of blockchain objects associated with the first blockchain, representing the message; trigger the message object to generate an announcement; and generate the token object in the set of blockchain objects in response to detection of the announcement.

This variation of the method S100 further includes transmitting the first transaction to a distributed network associated with the first blockchain for commitment in a second block in the first blockchain in Step S140.

### 1.2 Variation: Second Bridge Protocol

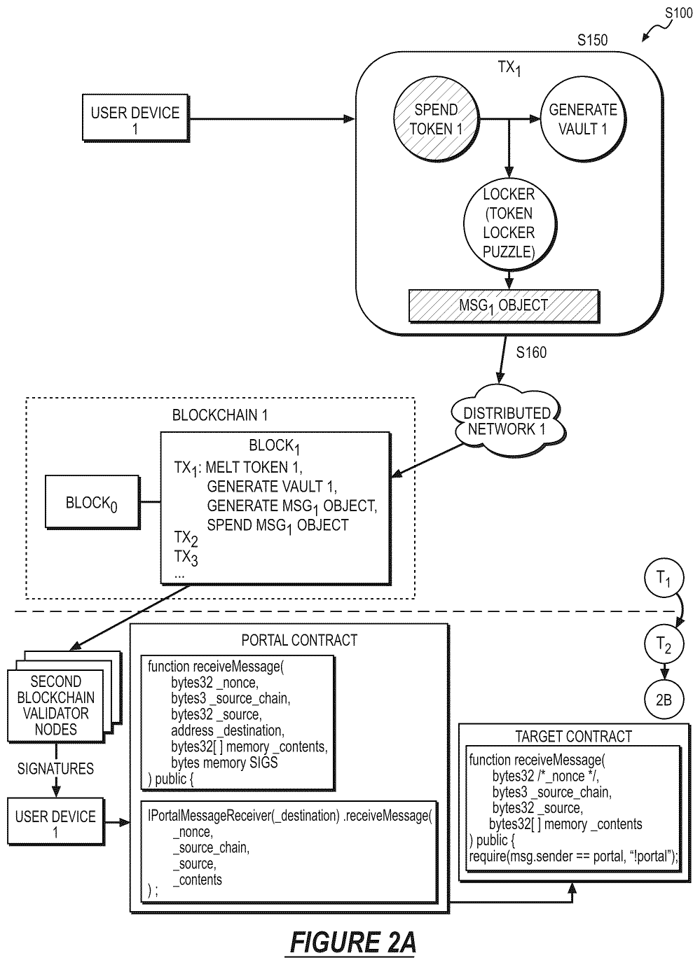

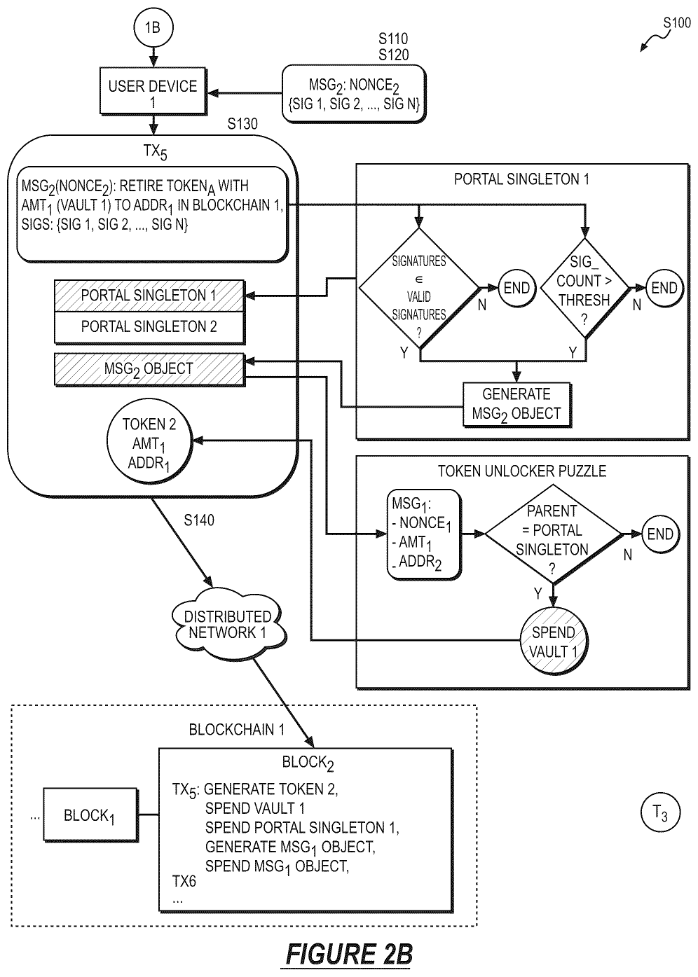

As shown in FIGS. 2A and 2B, one variation of the method S100 for communicating data between a first blockchain and a second blockchain includes: accessing a message identifier for a first message associated with the second blockchain, the first message representing retirement of a token associated with the second blockchain, the token characterized by a second amount of a second asset associated with the second blockchain in Step S110; and accessing a set of signatures representing detection of the first message in a first block in the second blockchain by validator nodes in a set of validator nodes for the first blockchain in Step S120. The first message contains a representation of the message identifier.

This variation of the method S100 also includes, in Step S130, generating a first transaction including the set of signatures and configured to: in response to detecting the set of signatures, trigger a first portal object to generate a first message object, in a set of blockchain objects associated with the first blockchain, representing the first message; trigger the first message object to generate an announcement; remove a first vault object from the set of blockchain objects, the first vault object characterized by a first amount of a first asset associated with the first blockchain; and generate a token object in the set of blockchain objects in response to detection of the announcement, the token object characterized by a third amount of the first asset based on the first amount of the first asset and the second amount of the second asset.

This variation of the method S100 further includes transmitting the first transaction to a distributed network associated with the first blockchain for commitment in a second block in the first blockchain in Step S140.

### 1.3 Variation: Portal Singleton

As shown in FIGS. 1A and 1B, one variation of the method S100 includes, at a first node in a distributed network: generating a first transaction configured to generate a first message representing generation of a first token associated with a first blockchain, the first message defining a first message identifier and a first destination address associated with the first blockchain; and transmitting the first transaction to the distributed network for commitment in a first block of the second blockchain.

The method S100 also includes, at a first validator node in a set of validator nodes: accessing the first block of the second blockchain; and, in response to detecting the first message in the first block, generating a first signature in a first set of signatures associated with the first message, the first signature associated with the first validator node and confirming presence of the first message in the first block of the second blockchain.

The method S100 further includes, at a second node in the distributed network: accessing the set of signatures associated with the first message in Step S120; generating a second transaction including the first message identifier and the set of signatures in Step S130; and transmitting the second transaction to the distributed network for commitment in a second block of the first blockchain in Step S140. The second transaction is configured to: trigger a portal singleton to generate a message object representing the first message in response to detecting a quantity of signatures in the set of signatures exceeding a threshold quantity; spend the message object; and generate the first token associated with the first blockchain in response to spending the message object.

### 2. Applications

Generally, a computer system (e.g., a set of nodes in a distributed network, a set of computing devices) can execute Steps of the method S100: to record a message—representing data for a target recipient within a first blockchain (e.g., a proof-of-space-based blockchain)—in a block of a second blockchain (e.g., a proof-of-stake-based blockchain, a proof-of-work-based blockchain); to verify existence of the message in the block of the second blockchain by a first group of validator nodes associated with the first blockchain; and to relay the message from the second blockchain to the first blockchain in response to verifying existence of the message by the group of validator nodes, thereby enabling communication between the first blockchain and the second blockchain.

For example, the computer system can execute Steps of the method S100: to retrieve a set of signatures confirming presence of a message—representing generation of a token within a first blockchain—in the second blockchain from the first group of validator nodes; to verify the set of signatures and a count of signatures in the set of signatures; and to trigger a portal blockchain object (or a “portal object”) to generate a message blockchain object (or a “message object”) representing the message, defining characteristics of the token, in response to the count of signatures exceeding a threshold count representing consensus; and to generate the token within the first blockchain according to the characteristics defined in the message by spending the message blockchain object.

Accordingly, the computer system can generate (or “mint”) the token as a tokenized representation of a second asset—associated with the second blockchain—operable on the first blockchain, thereby extending functionality of the first blockchain to a user of the second blockchain.

More specifically, the computer system can execute Steps of the method S100: to execute a validation and consensus protocol based on communications external to the first blockchain; and to establish trust in these communications absent inspection of the content within these communications. Therefore, the computer system can execute Steps of the method S100 to implement a bridge protocol while complying with regulatory requirements of certain nodes participating in the bridge protocol as validators (rather than issuers of digital assets).

### 2.1 Messages From First Blockchain to Second Blockchain

Additionally, the computer system can execute Steps of the method S100: to generate a message object—representing a message for a target recipient (e.g., a target contract) associated with the second blockchain—in the first blockchain; to verify existence of the message object by a second group of validator nodes associated with the second blockchain; and to relay the message from the first blockchain to the second blockchain in response to verifying existence of the message by the second group of validator nodes, thereby enabling communication between the first blockchain and the second blockchain.

For example, the computer system can execute Steps of the method S100: to generate a message object representing a message—indicating retirement (or “melting”) of the token in the first blockchain—for a target recipient (e.g., a smart contract) in the second blockchain; to retrieve a set of signatures confirming presence of the message in the first blockchain from the second group of validator nodes; and to trigger a portal contract to transmit contents of the message (e.g., an amount of an asset for transfer, a destination address) to the target recipient in the second blockchain.

More specifically, the computer system can execute Steps of the method S100: to identify the token—representing a first amount of a first asset associated with the first blockchain—as retired based on the message object; and issue a second amount of a second asset, associated with the second blockchain, to a destination address associated with the second blockchain according to the message.

Therefore, the computer system can: retire (or “melt”) the token from the first blockchain; and transfer value associated with the token to the destination address associated with the second blockchain.

### 2.2 Variation: Non-fungible Tokens

As described herein, the computer system executes Steps of the method S100 to trigger a portal blockchain object to: verify consensus between a set of validator nodes based on a set of signatures associated with a message representing generation of a token (e.g., a fungible token) within the first blockchain; and generate a message object representing the message in response to consensus between the set of validator nodes.

However, the computer system can similarly execute Blocks of the method S100 to trigger the portal object to: verify consensus between a set of validator nodes based on a set of signatures associated with a message representing any content (e.g., a smart contract, a data structure, a non-fungible token) associated with the first blockchain and a second blockchain; and generate a message object representing the message in response to consensus between the set of validator nodes.

### 3. Terminology

Generally, a “blockchain object” is referred to herein as a representation of state within a block on a blockchain.

Generally, a “puzzle” is referred to herein as executable program code represented in a blockchain object.

Generally, a “solution” is referred to herein as a set of arguments passed to a puzzle for execution therewith.

Generally, a “condition” is referred to herein as an output responsive to execution of a puzzle according to a solution.

Generally, an “assertion” as referred to herein is an output, responsive to execution of a puzzle according to a solution, that is valid in response to evaluating to TRUE.

Generally, “spend” is referred to herein as executing a puzzle—represented in a blockchain object—according to a solution.

Generally, a “signature” is referred to herein as a mathematical scheme for verifying authenticity of digital messages and/or data.

Generally, a “node” is referred to herein as a computing device configured to generate a transaction configured to interact with (e.g., generate, spend) a blockchain object.

Generally, a “full node” is referred to herein as a computing device configured: to validate pending transactions (e.g., in a mempool) for inclusion in a block of a blockchain; to generate the block including validated transactions; and to append the block to the blockchain.

Generally, a “mempool” as referred to herein is a collection of pending transactions stored (e.g., in memory) by a full node (and/or by a set of full nodes) for confirmation and inclusion in a block of the blockchain.

Generally, a “validator node” is referred to herein as a computing device associated with a first blockchain and configured to: detect a message in a block of the second blockchain; and generate a signature confirming presence of the message in the block of the second blockchain.

Generally, a “token” is referred to herein as a blockchain object characterized by a tokenized representation of a second asset—associated with a second blockchain—operable on the first blockchain.

### 4. Blockchain Structure

Generally, a computer system can include a distributed network including nodes (e.g., computing devices) interconnected through a communication medium (e.g., the Internet, a wide area network, a local area network). Each node in the distributed network can: store a copy of a decentralized database (or a “blockchain”); and execute a trustless consensus protocol associated with a state of the decentralized database. The distributed network can include a set of full nodes configured to execute the consensus protocol to extend a blockchain (e.g., a proof-of-space-based blockchain).

A blockchain can include a data structure including a series of blocks. A block can include a set of transactions between addresses representing entities. For example, the set of transactions can include cryptocurrency transactions and/or smart contracts that enforce specific node behavior.

In one implementation, the set of nodes generates and adds new blocks to the blockchain. For example, the set of nodes can generate and add new blocks to the blockchain based on a proof-of-space.

### 4.1 Generating Blockchain Objects

Generally, a node in the distributed network can submit a transaction (e.g., a network message) to generate a new blockchain object (e.g., a coin, a token, a singleton) representing a state to be recorded on the blockchain. More specifically, the node can submit the transaction defining: a representation of program code (or a “puzzle hash”); a value representing an amount of an asset (e.g., an amount of a cryptocurrency); and/or a unique identifier (or an “object ID”) of another blockchain object from which the new blockchain object will be generated, such as described in U.S. patent application Ser. No. 18/107,430.

A full node (or a subset of full nodes) in the distributed network can validate the transaction and generate a subsequent block—including the transaction—in the blockchain, thereby adding the blockchain object to a set of blockchain objects (e.g., a set of extant blockchain objects) on the blockchain. Additionally, the node can generate the subsequent block, including an object record specifying the set of blockchain objects—including the newly generated blockchain object—on the blockchain.

Accordingly, nodes in the distributed network can access the object record, included in a block (e.g., a most current block) of the blockchain, to identify the set of blockchain objects—including the newly generated blockchain object—on the blockchain, each blockchain object in the set of blockchain objects specifying: a puzzle hash; a value representing an amount of an asset; and an object identifier.

### 4.2 Spending Blockchain Objects

Generally, a node in the distributed network can submit a transaction to execute (or “spend”) a target blockchain object in the set of blockchain objects. More specifically, a node can submit a transaction defining a set of features including a target object ID, a target puzzle, a set of arguments (or a “solution”) for the target puzzle, and/or a signature.

Based on the set of features, a full node can: identify a blockchain object on the blockchain with which the transaction is associated; validate the transaction; execute the target puzzle according to the solution to generate a set of outputs (or a set of “conditions”); and generate a subsequent block—including the transaction—of the blockchain. Additionally, the full node can generate the subsequent block defining the set of conditions.

For example, the computer system can implement methods and techniques described in U.S. patent application Ser. No. 17/966,214, filed on 14-OCT.-2022, U.S. patent application Ser. No. 17/966,226, filed on 14-OCT.-2022, and U.S. patent application Ser. No. 18/107,430, filed on 08-FEB.-2023: to generate a transaction configured to spend a blockchain object; to submit the transaction to the distributed network for validation and inclusion in a block of the blockchain; to validate the transaction as a validated transaction; to generate a new block including the validated transaction; and to append the new block to the blockchain.

### 4.3 Portal Singleton

In one implementation, the computer system includes a portal blockchain object (hereinafter a “portal object”) in a set of blockchain objects, such as a portal singleton. The portal object is characterized by: a value representing an amount of an asset (e.g., an amount of a cryptocurrency, “1”) associated with the first blockchain; a puzzle hash representing program code (or “behavior”) of the portal object (e.g., a puzzle hash representing a puzzle representing program code of the portal object); and a parent identifier associated with a parent of the portal object.

In one example, the portal object is characterized by a parent identifier associated with a launcher identifier.

In another example, the portal object is characterized by a first parent identifier associated with a preceding portal object, the preceding portal object characterized by a second parent identifier associated with the launcher identifier.

In this implementation, a node generates a transaction configured to: remove the portal object from the set of blockchain objects; and generate a second portal object—in the set of blockchain objects—based on the portal object.

For example, the node can generate the transaction configured to: remove a first portal object—from the set of blockchain objects—characterized by a first parent identifier and a first puzzle hash representing a first puzzle; and generate the second portal object characterized by a second parent identifier, associated with the first portal object, and a second puzzle hash representing a second puzzle based on the first puzzle.

Accordingly, the node: spends the first portal object; and generates the second portal object based on the first portal object (or “regenerates” the first portal object as the second portal object according to a singleton layer—in the first puzzle corresponding to the first puzzle hash—that enforces that a single instance of a portal object is associated with a singleton identity (e.g., a launcher identifier)).

### 5. Message Object

The method S100 includes: accessing a first message identifier for a first message associated with the second blockchain in Step S110; and accessing a set of signatures representing detection of the first message in a first block in the second blockchain by validator nodes in a set of validator nodes for the first blockchain in Step S120. The first message contains a representation of the first message identifier.

Step S130 of the method S100 recites generating a first transaction including the set of signatures and configured to: in response to detecting the set of signatures, trigger a first portal object to generate a first message object, in a set of blockchain objects associated with the first blockchain, representing the first message; remove the first portal object from the set of blockchain objects; and generate a second portal object, in the set of blockchain objects, based on the first portal object.

Step S130 of the method S100 recites transmitting the first transaction to a distributed network associated with the first blockchain for commitment in a second block in the first blockchain.

Generally, in Steps S110, S120, S130, and S140, the computer system can execute a messaging protocol that communicates data between a first blockchain (e.g., a proof-of-space-based blockchain) and a second blockchain (e.g., a proof-of-stake-based blockchain, a proof-of-work-based blockchain).

The computer system can include or interface with a set of validator nodes (e.g., eleven computing devices) in a first distributed network associated with the first blockchain.

In one implementation, the set of validator nodes: accesses a target block (e.g., a most recent block) of the second blockchain; detects a message recorded in the target block and designating a recipient associated with the first blockchain; and generates a set of signatures confirming presence of the message in the target block of the second blockchain.

For example, the message can represent: a first source address (e.g., a contract address) associated with the second blockchain; and a first destination address (e.g., a puzzle hash) associated with the first blockchain.

In another implementation, a node (e.g., a user device): accesses the set of signatures; generates a transaction configured to generate a message blockchain object (hereinafter a “message object”) representing the message in response to a quantity of signatures in the set of signatures exceeding a threshold quantity; and transmits the transaction to the first distributed network for commitment in a block of the first blockchain.

More specifically, the node can generate and configure the transaction to trigger a portal object (e.g., a portal singleton) to generate the message object representing the message in response to the quantity of signatures, in the set of signatures, exceeding the threshold quantity.

Accordingly, the computer system can: detect a message originating from the second blockchain; validate presence of the message in the second blockchain; and generate a message object—in a set of blockchain objects associated with the first blockchain—representing the message in order to enable communication from the second blockchain to the first blockchain. The computer system can then spend the message object in order to generate and/or spend another blockchain object(s), in the set of blockchain objects, based on the message.

### 5.1 Second Blockchain Message Event

Generally, a node can generate a message in a block of the second blockchain.

In one implementation, a node (e.g., a first user device) generates a transaction configured to generate (or emit) a message in the second blockchain.

For example, the message can specify: a message identifier (e.g., a nonce) associated with the message; an identifier of a source blockchain, such as the second blockchain; an identifier of a destination blockchain, such as the first blockchain (or another destination blockchain); a source address (e.g., a contract address) associated with the source blockchain; a destination address (e.g., a puzzle hash, a launcher identifier) associated with the destination blockchain; and/or additional message contents; etc.

More specifically, the node can generate and configure the transaction to call a function that generates (or emits) an event representing the message in the second blockchain.

In this implementation, the node transmits the transaction to a distributed network (e.g., a second distributed network associated with the second blockchain) for commitment in a block of the second blockchain.

In one variation, the node: transmits the transaction to a sequencer—associated with the second blockchain—for commitment in a block of the second blockchain; and receives confirmation of receipt of the transaction from the sequencer.

### 5.1 Message Detection and Validation

Generally, the set of validator nodes can: detect the message recorded in a block of the second blockchain; generate a set of signatures confirming presence of the message in the block of the second blockchain; and transmit the set of signatures to a set of communication relays—representing a “message board”—associated with the set of validator nodes.

In one implementation, a first validator node in the set of validator nodes: accesses a target block (e.g., a most recent block) of the second blockchain; and detects the message represented in the target block.

For example, the first validator node can detect presence of the event—representing the message—in the target block.

In another implementation, the first validator node generates a first signature, in the set of signatures, associated with the message and confirming presence of the message in the target block of the second blockchain.

For example, the first validator node can generate the first signature representing: the identifier of the source blockchain (e.g., the second blockchain); the identifier of the destination blockchain (e.g., the first blockchain); and the message identifier (e.g., the nonce).

Additionally, the first validator node can generate the first signature associated with an object identifier of a target portal object (e.g., an extant portal object in the first blockchain).

More specifically, the first validator node can generate the first signature based on a first private key (e.g., a “hot” key stored in local memory of the first validator node) associated with the first validator node.

In this implementation, the first validator node transmits (or “posts”) the first signature associated with the message to a first communication relay, in the set of communication relays, associated with the first validator node.

Additionally, the first validator node can transmit the first signature associated with the message to each communication relay in the set of communication relays.

The computer system repeats the foregoing methods and techniques at each validator node in the set of validator nodes: to access a target block of the second blockchain; to detect the message represented in the target block; to generate a signature—in the set of signatures and based on a private key associated with the validator node—associated with the message and confirming presence of the message in the target block of the second blockchain; and to transmit the signature to a communication relay associated with the validator node (and/or each communication relay in the set of communication relays).

Accordingly, each validator node can independently confirm presence of communications (e.g., the message) represented in the second blockchain in order to establish trust in these communications absent inspection of the content within these communications. Therefore, the computer system can implement a bridge protocol (e.g., a token bridge protocol) while complying with regulatory policies of certain nodes participating in the bridge protocol as validators (rather than issuers of digital assets).

### 5.2 Message Object Generation

Generally, a node (e.g., the first user device, a second user device) can: access the set of signatures associated with the message from the set of communication relays; generate a transaction including the set of signatures and the message identifier associated with the message; and transmit the transaction to a distributed network (e.g., a first distributed network associated with the first blockchain) for commitment in a block of the first blockchain.

More specifically, the node can generate and configure the transaction to: trigger a portal object to generate a message object representing the message in response to detecting a quantity of signatures in the set of signatures exceeding a threshold quantity.

Accordingly, the computer system (e.g., the portal object) can: verify consensus among the set of validator nodes that the message is recorded in the second blockchain; and generate a message object representing the message in the first blockchain in response to consensus among the set of validator nodes.

### 5.2.1 Signature Retrieval

In one implementation, the node: accesses a message identifier for a message recorded in the second blockchain in Step S110; and accesses a set of signatures representing detection of the message—characterized by the message identifier—in a block of the second blockchain by the set of validator nodes in Step S120.

In one example, the node accesses a first signature—in the set of signatures and associated with the first validator node—from a first communication relay, in the set of communication relays, associated with the first validator node.

In this example, the node repeats the foregoing methods and techniques for each signature in the set of signatures to access the signature—associated with a validator node in the set of validator nodes—from a communication relay, in the set of communication relays, associated with the validator node.

In another example, the node accesses the set of signatures from a first communication relay associated with the first validator node.

In another example, the node accesses a first subset of signatures (e.g., multiple signatures)—in the set of signatures associated with the message—from the first communication relay associated with the first validator node.

In this example, the node repeats the foregoing methods and techniques to access subsets of signatures, in the set of signatures, from a communication relay in the set of communication relays.

In another implementation, the node accesses the set of signatures in response to expiration of a target duration (e.g., generation of a predefined quantity of blocks in the second blockchain).

In one variation, the node accesses the set of signatures in response to receiving confirmation of receipt of the transaction—configured to generate the message—from the sequencer.

### 5.2.2 Message Object Generation

In one implementation, in Step S130, the node generates a transaction including the set of signatures and configured to trigger a first portal object (e.g., via a spend of the first portal object) to generate a message object—in the set of blockchain objects associated with the first blockchain—representing the message in response to detecting a quantity of signatures, in the set of signatures, exceeding a threshold quantity.

More specifically, the node can generate and configure the transaction to trigger the first portal object: to calculate a quantity of signatures in the set of signatures; and to generate the message object representing the message in response to detecting the quantity of signatures exceeding a threshold quantity (e.g., six signatures).

For example, the message object can represent (or specify): the message identifier associated with the message; the identifier of the source blockchain (e.g., the second blockchain); the identifier of the destination blockchain (e.g., the first blockchain); the source address associated with the source blockchain; the destination address associated with the destination blockchain; and/or additional message contents; etc.

Additionally, the node can generate and configure the transaction to trigger the first portal object to generate the message object characterized by a parent identifier associated with the first portal object.

In this implementation, the node executes the foregoing methods and techniques to generate and configure the transaction to: spend the first portal object, and thereby remove the first portal object from the set of blockchain objects, to generate the message object; and generate a second portal object based on the first portal object.

For example, the node can generate the transaction configured to: remove the first portal object—from the set of blockchain objects—characterized by a first parent identifier and a first puzzle hash representing a first puzzle; and generate the second portal object characterized by a second parent identifier, associated with the first portal object, and a second puzzle hash representing a second puzzle based on the first puzzle.

In another implementation, in Step S140, the node transmits the transaction to a first distributed network associated with the first blockchain for commitment in a block in the first blockchain.

Accordingly, the node can generate and configure the transaction to spend the first portal object, which triggers the first portal object to: generate the message object in response to the quantity of signatures—in the set of signatures—exceeding the threshold quantity; and generate a second portal object based on the first portal object (or “regenerate” the first portal object as the second portal object).

In one variation, the node calculates a quantity of signatures in the set of signatures associated with the message. In response to the quantity of signatures exceeding a threshold quantity (e.g., six signatures), the node executes the foregoing methods and techniques: to generate a transaction configured to trigger a first portal object to generate a message object representing the message in the first blockchain; and to transmit the transaction to the first distributed network associated with the first blockchain for commitment in a block in the first blockchain.

### 5.2.3 Message Uniqueness

In one variation, the node executes the foregoing methods and techniques to generate the transaction configured to: trigger the first portal object to generate the message object representing the message associated with the message identifier; remove the first portal object from the set of blockchain objects; and generate the second portal object, in the set of blockchain objects, based on the first portal object.

In this variation, the node generates and configures the transaction: to remove the first portal object characterized by a first puzzle hash representing a first puzzle; and generate the second portal object characterized by a second puzzle hash representing a second puzzle based on the first puzzle and the message identifier.

More specifically, the node can generate and configure the transaction: to spend the first portal object to generate the message object representing the message; to embed the message identifier of the message (e.g., based on the identifier of the second blockchain and/or the nonce of the message) and/or the message into the second puzzle; to generate the second puzzle hash for the second portal object according to the second puzzle and a cryptographic hash function; to generate the second portal object characterized by the second puzzle hash; and to assign an object identifier to the second portal object based on the second puzzle hash.

The computer system can execute the foregoing methods and techniques to embed identifiers of a set of prior messages (e.g., relayed messages) into the second puzzle of the second portal object.

Accordingly, when the first validator node later generates a signature—for a second message—associated with the object identifier of the second portal object, the first validator node can verify absence of a second message identifier of the second message represented in the object identifier of the second portal object (and thus absence of the second message identifier and/or the second message embedded in the second puzzle of the second portal object). Therefore, the computer system can ensure that a message is relayed a single time from the second blockchain to the first blockchain.

Additionally or alternatively, the first validator node can verify presence of the message identifier and/or the message in the second puzzle of the second portal object.

### 5.3 Message Object Spend

Generally, in Steps S130 and/or S110, a node can generate a transaction configured to: spend the message object representing the message and specifying a target puzzle hash (e.g., a recipient of the message) of a target blockchain object; and spend the target blockchain object according to the message in response to spending the message object. The node can then transmit the transaction to the first distributed network associated with the first blockchain for commitment in a block in the first blockchain in Steps S140 and/or S112.

In one implementation, in Block S130, the node generates the transaction configured to trigger the message object—specifying the target puzzle hash—to generate an announcement for the target blockchain object associated with the target puzzle hash.

For example, the node can generate and configure the transaction to trigger the message object to generate the announcement specifying an object identifier of the target blockchain object (and/or an object identifier of the message object).

In this example, the node generates and configures the transaction to spend the message object—and thereby remove the message object from the set of blockchain objects—to trigger the message object to generate the announcement.

In this implementation, the node generates and configures the transaction to spend the target blockchain object based on the announcement.

For example, the node can generate and configure the transaction to trigger the target blockchain object to generate a token blockchain object (hereinafter a “token object”), in the set of blockchain objects, in response to detection of the announcement specifying the object identifier of the target blockchain object.

Additionally or alternatively, the node can generate and configure the transaction: to trigger the message object—characterized by a parent identifier associated with the first portal object—to generate an assertion representing the parent identifier associated with the first portal object; and to trigger the target blockchain object to generate the token object in response to detection of the assertion representing the parent identifier associated with the first portal object.

In another implementation, in Step S140, the node transmits the transaction to the first distributed network associated with the first blockchain for commitment in a block in the first blockchain.

Accordingly, the computer system can: generate a message object—representing a message recorded in the second blockchain and specifying a target puzzle hash—in a set of blockchain objects associated with the first blockchain; spend the message object to generate an announcement for the target blockchain object (and/or to generate an assertion certifying generation of the message object by a portal object); and spend a target blockchain object associated with the target puzzle hash in response to detection of the announcement (and/or the assertion), thereby enabling the computer system to execute a transaction that is dependent on data (e.g., the message) communicated between the first blockchain and the second blockchain.

### 5.4 Transmitting Message From First Blockchain to Second Blockchain

In one implementation, a node: generates a transaction configured to generate a message object, in the set of blockchain objects associated with the first blockchain, representing a message for a target recipient (e.g., a target contract) associated with the second blockchain; and transmit the transaction to the first distributed network associated with the first blockchain for commitment in a block in the first blockchain.

For example, the message object can represent (or specify): the message identifier associated with the message; the identifier of the source blockchain (e.g., the first blockchain); the identifier of the destination blockchain (e.g., the second blockchain, another blockchain); the source address associated with the source blockchain; the destination address (e.g., a target contract address) associated with the destination blockchain; and/or additional message contents; etc.

In this example, the message object can represent a value representing an amount of an asset associated with the first blockchain (e.g., a fee amount allocated to an address associated with a full node that commits the transaction to a block in the first blockchain) exceeding a threshold amount in order to control a quantity of messages exchanged between the first blockchain and the second blockchain.

In this implementation, the node generates and configures the transaction to generate the message object associated with an object identifier representing a message identifier for the message.

Additionally, the node can generate and configure the transaction to spend the message object, and thereby remove the message object from the set of blockchain objects.

Alternatively, the node (or another another) can: generate a second transaction configured to spend the message object; and transmit the second transaction to the first distributed network for commitment in a block in the first blockchain.

In another implementation, a validator node(s) associated with the second blockchain: accesses the block of the first blockchain; detects the message object representing the message, such as based on the object identifier of the message object as a nonce (and/or based on a hash of the identifier of the first blockchain and the nonce); and generates a signature(s) representing detection of the message recorded in the first blockchain.

In another implementation, a node associated with the second blockchain: accesses the signature(s) representing detection of the message recorded in the first blockchain; and calls a function (e.g., a receive message function)—of a portal contract associated with the second blockchain—based on the signature(s), which causes the portal contract to transmit contents of the message to the destination address (e.g., the target contract) in the second blockchain.

Therefore, the computer system can relay a message—represented in a message object—in the first blockchain to a target recipient associated with the second blockchain, thereby enabling the computer system to execute a smart contract (e.g., the target contract) that is dependent on data (e.g., the message) communicated between the first blockchain and the second blockchain.

### 6. First Bridge Protocol

The method S100 includes: accessing a message identifier for a message associated with the second blockchain, the message representing generation of a token object associated with the first blockchain in Step S110; and accessing a set of signatures representing detection of the message in a first block in the second blockchain by validator nodes in a set of validator nodes for the first blockchain in Step S120. The message contains a representation of the message identifier.

Step S130 of the method S100 recites generating a first transaction including the set of signatures and configured to: in response to detecting the set of signatures, trigger a first portal object to generate a message object, in a set of blockchain objects associated with the first blockchain, representing the message; trigger the message object to generate an announcement; and generate the token object in the set of blockchain objects in response to detection of the announcement.

Step S140 of the method S100 recites transmitting the first transaction to a distributed network associated with the first blockchain for commitment in a second block in the first blockchain.

Generally, in Steps S110, S120, S130, and S140, and as shown in FIGS. 1A, 1B, and 1C, the computer system can execute a first bridge protocol (hereinafter the “first bridge”) that communicates information between the first blockchain and the second blockchain.

More specifically, the computer system can execute the foregoing methods and techniques: to access a target block (e.g., a most recent block) of the second blockchain; to detect a message recorded in the target block and representing generation of a token associated with the first blockchain; and to generate a set of signatures confirming presence of the message in the target block of the second blockchain.

For example, the message can represent: a source address (e.g., a contract address) associated with the second blockchain; a destination address (e.g., a puzzle hash) associated with the first blockchain; a first amount of a first asset associated with the first blockchain; and a second amount of a second asset associated with the second blockchain.

The computer system can then execute the foregoing methods and techniques: to access the set of signatures; to generate a transaction configured to trigger a portal object to generate the message object representing the message in response to detecting a quantity of signatures in the set of signatures exceeding a threshold quantity; and to transmit the transaction to the first distributed network for commitment in a block in the first blockchain.

Additionally, the computer system can execute the foregoing methods and techniques: to spend the message object; and to generate the token object, in the set of blockchain objects associated with the first blockchain, in response to spending the message object.

For example, the token object can be characterized by: an object identifier; the first amount of the first asset associated with the first blockchain; and the destination address associated with the first blockchain.

Therefore, the computer system can generate (or “mint”) the token object as a tokenized representation of the second asset—associated with the second blockchain—operable on the first blockchain, thereby extending functionality of the first blockchain to a user of the second blockchain based on messages (rather than transfer of the second asset) recorded in blocks of the second blockchain.

### 6.1 First Bridge: Second Blockchain Message Event

In one implementation, a node (e.g., a first user device) executes the foregoing methods and techniques to generate a transaction configured to generate (or emit) a message—representing generation of a token object associated with the first blockchain—in the second blockchain.

For example, the message can specify: a message identifier (e.g., a nonce) associated with the message; an identifier of a source blockchain, such as the second blockchain; an identifier of a destination blockchain, such as the first blockchain (or another destination blockchain); a source address (e.g., a contract address) associated with the source blockchain; a destination address (e.g., a puzzle hash, a launcher identifier) associated with the destination blockchain; a first amount of a first asset associated with the source blockchain; a second amount of a second asset associated with the destination blockchain; and/or additional message contents; etc.

In this implementation, the node executes the foregoing methods and techniques to transmit the transaction to the second distributed network associated with the second blockchain for commitment in a block in the second blockchain.

### 6.2 First Bridge: Message Detection and Validation

In another implementation, the computer system executes the foregoing methods and techniques: to detect the message recorded in a block in the second blockchain; to generate a set of signatures confirming presence of the message in the block in the second blockchain; and to transmit the set of signatures to a set of communication relays.

For example, for each validator node in a set of validator nodes associated with the first blockchain, the validator node can: access a target block of the second blockchain; detect the message represented in the target block; generate a signature—based on a private key associated with the validator node—associated with the message and confirming presence of the message in the target block of the second blockchain; and transmit the signature to a communication relay associated with the validator node (and/or each communication relay in the set of communication relays).

### 6.3 First Bridge: Message Object Generation

In one implementation, a node (e.g., the first user device, a second user device) executes the foregoing methods and techniques: to access a message identifier for the message recorded in the second blockchain in Step S110; and to access a set of signatures representing detection of the message—characterized by the message identifier—in the second blockchain by the set of validator nodes in Step S120.

In another implementation, in Step S130, the node executes the foregoing methods and techniques to generate a first transaction including the set of signatures and configured to: trigger a first portal object to generate a message object—in the set of blockchain objects associated with the first blockchain—representing the message in response to detecting a quantity of signatures, in the set of signatures, exceeding a threshold quantity; remove the first portal object from the set of blockchain objects; and generate a second portal object in the set of blockchain objects based on the first portal object.

For example, the message object can represent (or specify): the message identifier associated with the message; the identifier of the source blockchain (e.g., the second blockchain); the identifier of the destination blockchain (e.g., the first blockchain); the source address associated with the source blockchain; the destination address associated with the destination blockchain; the first amount of the first asset associated with the first blockchain; the second amount of the second asset associated with the second blockchain; and/or additional message contents; etc.

Additionally, the node can generate and configure the first transaction to trigger the first portal object to generate the message object characterized by a parent identifier associated with the first portal object.

In this implementation, in Step S140, the node executes the foregoing methods and techniques to transmit the first transaction to a first distributed network associated with the first blockchain for commitment in a block in the first blockchain.

### 6.4 First Bridge: Token Object Minting

In one implementation, the node generates the first transaction configured to generate the token object, in the set of blockchain objects, according to the message object. The token object is characterized by: an object identifier associated with the token object; the destination address associated with the first blockchain; the first amount of the first asset associated with the first blockchain; and/or the second amount of the second asset associated with the second blockchain; etc.

More specifically, the node can generate and configure the first transaction to: spend the message object representing generation of the token object associated with the first blockchain; and generate the token object in response to spending the message object.

For example, the node can generate and configure the first transaction to: spend the message object—removing the message object from the set of blockchain objects associated with the first blockchain—which triggers the message object to generate an announcement specifying an object identifier associated with the token object; and generate the token object characterized by the object identifier in response to detection of the announcement.

Additionally, the computer system includes a token minter puzzle that: interprets the message represented in the message object; and generates the token object according to the message.

In particular, the token minter puzzle can: detect the message object representing generation of a token object characterized by a target object identifier, a destination address associated with the first blockchain, and a first amount of a first asset associated with the first blockchain; and generate the token object characterized by the target object identifier, the destination address, and the first amount of the first asset.

Additionally or alternatively, the node can generate and configure the first transaction: to trigger the message object—characterized by a parent identifier associated with the first portal object—to generate an assertion representing the parent identifier associated with the first portal object; and to generate the token object in response to detection of the assertion representing the parent identifier associated with the first portal object.

In one variation, the node generates the transaction configured to: spend the message object representing generation of the token object; trigger the token minter puzzle to generate a first token object (or an “eve token object”) in response to spending the message object; spend the first token object; and generate a second token object (or a “payout token object”)—including a parent identifier associated with the first token object—in response to spending the first token object.

In this variation, the second token object is associated with (e.g., sent to) the destination address associated with the first blockchain.

In another variation, the node generates the first transaction configured to: spend the message object; spend a security object associated with a first signature; trigger the token minter puzzle to generate the first token object in response to spending the message object and the security object; spend the first token object; and generate a second token object—including a parent identifier associated with the first token object—in response to spending the first token object.

In another variation, the node generates the first transaction configured to: spend the message object to trigger the message object to generate an announcement; spend a security object associated with a first signature; trigger the token minter puzzle to generate the first token object in response to spending the message object and the security object; spend the first token object; and generate a second token object (or the “payout token object”)—including a parent identifier associated with the first token object—in response to spending the first token object.

For example, the node can generate and configure the first transaction to: spend the first token object in response to detection of the announcement; trigger the security object to generate an assertion representing a spend of the first token object; and trigger the token minter puzzle to generate the second token object in response to spending the first token object and in response to the assertion.

In this example, the second token object is characterized by a parent identifier associated with the first token object.

Accordingly, the computer system can generate the first transaction representing an offer file, the offer file including an aggregate signature based on the first signature and representing a spend of the message object—and a spend of the security object—in order to generate the token object. Therefore, by generating the first transaction representing the offer file including the aggregate signature based on the first signature, the computer system can increase security of the first transaction by preventing separation of the offer file from the first transaction.

In one variation, the node (or another another): generates a second transaction configured to spend the message object and generate the token object in response to spending the message object; and transmits the second transaction to the first distributed network for commitment in a block in the first blockchain.

### 6.5 First Bridge: Token Object Retirement

Step S150 of the method S100 recites generating a second transaction configured to: trigger a token burner puzzle associated with the token object to generate a second message object in the set of blockchain objects; and remove the second message object from the set of blockchain objects by spending the second message object. The second message object: represents a second message for the second blockchain, the second message representing retirement of the token object from the first blockchain; and is characterized by a destination address associated with the second blockchain.

Step 160 of the method S100 recites transmitting the second transaction to the distributed network associated with the first blockchain for commitment in a third block in the first blockchain.

Generally, in Steps S150 and S160, a node can generate a retirement transaction: specifying a destination address associated with the second blockchain; and configured to trigger a token object—representing a first amount of the first asset associated with the first blockchain—extant on the first blockchain to retire (or “melt”). The node can transmit the retirement transaction to the first distributed network for validation and commitment in a block of the first blockchain.

For example, the node can generate a retirement transaction: configured to melt the token object representing an amount of the first asset; and specifying a destination address associated with the second blockchain.

In one implementation, in Step S150, the node generates a transaction configured to trigger a token burner puzzle associated with a token object to generate a message object in the set of blockchain objects. The message object represents a message—for the second blockchain—representing retirement of a token object from the first blockchain.

For example, the node can generate the transaction configured to trigger the token burner puzzle of the token object to generate the message object representing the message and associated with an object identifier representing a message identifier for the message.

In this example, the message can specify: a message identifier (e.g., a nonce) associated with the message; an identifier of a source blockchain, such as the first blockchain; an identifier of a destination blockchain, such as the second blockchain (or another destination blockchain); a source address (e.g., a puzzle hash, a launcher identifier) associated with the source blockchain; a destination address (e.g., a contract address) associated with the destination blockchain; a first amount of a first asset associated with the source blockchain; a second amount of a second asset associated with the destination blockchain; and/or additional message contents; etc.

In this implementation, in Step S160, the node executes the foregoing methods and techniques to transmit the transaction to the first distributed network associated with the first blockchain for commitment in a block in the first blockchain.

Additionally, the node can generate and configure the transaction to remove the message object from the set of blockchain objects by spending the message object.

Alternatively, the node (or another node) can: generate a separate transaction configured to: spend the message object, and thereby remove the message object from the set of blockchain objects; and transmit the separate transaction to the first distributed network associated with the first blockchain for commitment in a block in the first blockchain.

In one variation, the node generates the first transaction configured to: spend a security object associated with a first signature; and trigger the token burner puzzle to generate the message object—representing retirement of the token object associated with a second signature—in response to spending the security object.

In this variation, the node generates the first transaction including an aggregate signature based on the first signature and the second signature.

In another implementation, the computer system executes the foregoing methods and techniques: to access the block of the first blockchain; to detect the message object representing the message, such as based on the object identifier of the message object as a nonce (and/or based on a hash of the identifier of the first blockchain and the nonce); and to generate a signature(s) representing detection of the message recorded in the first blockchain.

In this implementation, the computer system executes the foregoing methods and techniques: to access the signature(s) representing detection of the message recorded in the first blockchain; and to call a function (e.g., a receive message function)—of a portal contract associated with the second blockchain—based on the signature(s), which causes the portal contract to transmit contents of the message to the destination address (e.g., the target contract) in the second blockchain.

For example, the computer system can: identify the token object (e.g., based on the object identifier as a nonce) as retired according to the transaction; and issue the second amount of the second asset—associated with the second blockchain—to the destination address associated with the second blockchain.

In this example, the computer system can calculate the second amount of the second asset based on: the first amount of the first asset; a conversion rate between the first asset and the second asset; and/or a transaction fee(s) (e.g., network transaction fee, bridge transaction fee) for the retirement transaction.

Accordingly, the computer system can: retire (or “melt”) the token object from the first blockchain; and transfer value (e.g., the second amount of the second asset associated with the second blockchain) associated with the token object to the destination address associated with the second blockchain.

### 7. Second Bridge Protocol

Generally, as shown in FIGS. 2A and 2B, the computer system can execute a second bridge protocol (hereinafter the “second bridge”) that communicates information between the first blockchain and the second blockchain.

More specifically, a node can generate a transaction configured to spend a first token object associated with the first blockchain and characterized by: a first amount of a first asset associated with the first blockchain; and a source address associated with the first blockchain. The node can generate and configure the transaction to: generate a vault blockchain object (hereinafter a “vault object”) representing the first amount of the first asset; and trigger a token locker puzzle to generate a message object representing a message indicating the first amount of a first asset associated with the first blockchain, a destination address associated with the second blockchain, and/or additional contents. The node can then transmit the transaction to the first distributed network associated with the first blockchain for commitment in a block in the first blockchain.

The computer system can execute the foregoing methods and techniques: to detect the message object representing the message; to generate a signature(s) representing detection of the message recorded in the first blockchain; and to call a function (e.g., a receive message function)—of a portal contract associated with the second blockchain—based on the signature(s), which causes the portal contract to transmit contents of the message to the destination address (e.g., the target contract) in the second blockchain.

Therefore, a node associated with the second blockchain can generate a second token—characterized by the first amount of the first asset associated with the first blockchain and the destination address associated with the second blockchain—in the second blockchain based on the message represented in the message object recorded in the first blockchain, thereby extending functionality of the second blockchain to a user of the first blockchain based on messages (rather than transfer of the first asset) recorded in blocks of the first blockchain.

### 7.1 Second Bridge: Message Object Generation

Step S170 of the method S100 recites generating a second transaction configured to: generate the first vault object in the set of blockchain objects; trigger a locker object in the set of blockchain objects to generate an assertion representing the first vault object characterized by the first amount of the first asset; and trigger the locker object to generate a second message object representing a second message, the second message representing generation of the token associated with the second blockchain.

Step S180 of the method S100 recites transmitting the second transaction to the distributed network associated with the first blockchain for commitment in a third block in the first blockchain.

In one implementation, in Step S170, a node generates a transaction configured to: spend a first token object—in the set of blockchain objects associated with the first blockchain—characterized by a first amount of a first asset associated with the first blockchain; generate a first vault object, in the set of blockchain objects, representing the first amount of the first asset; and generate a locker blockchain object (hereinafter a “locker object”) characterized by a token locker puzzle.

More specifically, the node can generate and configure the transaction to trigger the locker object (e.g., trigger the token locker puzzle of the locker object) to: generate an assertion representing (e.g., certifying generation of) the vault object characterized by the first amount of the first asset; and, in response to detection of the assertion, generate a message object representing a message for the second blockchain and associated with an object identifier representing a message identifier for the message. The message represents generation of a second token associated with the second blockchain.

For example, the message object can specify: a message identifier (e.g., a nonce) associated with the message; an identifier of a source blockchain, such as the first blockchain; an identifier of a destination blockchain, such as the second blockchain (or another destination blockchain); a source address (e.g., a puzzle hash, a launcher identifier) associated with the source blockchain; a destination address (e.g., a contract address) associated with the destination blockchain; the first amount of the first asset associated with the source blockchain; a second amount of a second asset associated with the destination blockchain; and/or additional message contents; etc.

In this example, the message object can represent a value representing an amount of an asset associated with the first blockchain (e.g., a fee amount allocated to an address associated with a full node that commits the transaction to a block of the first blockchain) exceeding a threshold amount in order to control a quantity of messages exchanged between the first blockchain and the second blockchain.

In this implementation, in Step S180, the node executes the foregoing methods and techniques to transmit the transaction to the first distributed network associated with the first blockchain for commitment in a block in the first blockchain.

In one variation, the node generates and configures the transaction configured to: spend a security object associated with a first signature; and trigger the locker object to generate the message object in response to spending the security object.

In this variation, the node generates the transaction including an aggregate signature based on the first signature.

### 7.2 Second Bridge: Token Retirement

The method S100 includes: accessing a message identifier for a first message associated with the second blockchain in Step S110; and accessing a set of signatures representing detection of the first message in a first block in the second blockchain by validator nodes in a set of validator nodes for the first blockchain in Step S120. The first message contains a representation of the message identifier and represents retirement of a token associated with the second blockchain. The token is characterized by a second amount of a second asset associated with the second blockchain.

Step S130 of the method S100 recites generating a first transaction including the set of signatures and configured to: in response to detecting the set of signatures, trigger a first portal object to generate a first message object, in a set of blockchain objects associated with the first blockchain, representing the first message; trigger the first message object to generate an announcement; remove a first vault object from the set of blockchain objects, the first vault object characterized by a first amount of a first asset associated with the first blockchain; and generate a token object in the set of blockchain objects in response to detection of the announcement, the token object characterized by a third amount of the first asset based on the first amount of the first asset and the second amount of the second asset.

Step S140 of the method S100 recites transmitting the first transaction to a distributed network associated with the first blockchain for commitment in a second block in the first blockchain.

In one implementation, a node can execute the foregoing methods and techniques to generate a message in a block of the second blockchain representing retirement of the second token associated with the second blockchain.

For example, the node can: generate a transaction specifying a destination address associated with the first blockchain and an amount of the second asset associated with the second blockchain; and transmit the first transaction for commitment in a block in the second blockchain.

In this example, the node can generate the first transaction configured to call a function that generates (or emits) an event representing the message in the second blockchain. The message can specify: a message identifier (e.g., a nonce) associated with the message; an identifier of a source blockchain, such as the second blockchain; an identifier of a destination blockchain, such as the first blockchain (or another destination blockchain); a source address (e.g., a contract address) associated with the source blockchain; a destination address (e.g., a puzzle hash, a launcher identifier) associated with the destination blockchain; a first amount of the first asset associated with the first blockchain; a second amount of the second asset associated with the second blockchain; and/or additional message contents; etc.

In this implementation, the computer system executes the foregoing methods and techniques: to detect the message recorded in a block in the second blockchain; to generate a set of signatures confirming presence of the message in the block in the second blockchain; and to transmit the set of signatures to a set of communication relays.

In another implementation, a node executes the foregoing methods and techniques: to access a message identifier for the message in Step S110; and to access the set of signatures representing detection of the message—characterized by the message identifier—in the second blockchain by the set of validator nodes in Step S120.

In another implementation, in Step S130, the node executes similar methods and techniques described above to generate a transaction configured to: trigger a first portal object (e.g., via a spend of the first portal object) to generate a message object, in the set of blockchain objects associated with the first blockchain, representing the message in response to detecting the set of signatures; to remove the first portal object from the set of blockchain objects; and to generate a second portal object, in the set of blockchain objects, based on the first portal object.

For example, the message object can represent (or specify): the message identifier associated with the message; the identifier of the source blockchain (e.g., the second blockchain); the identifier of the destination blockchain (e.g., the first blockchain); the source address (e.g., a contract address) associated with the source blockchain; the destination address (e.g., an unlocker puzzle) associated with the destination blockchain; the first amount of the first asset associated with the first blockchain; the second amount of the second asset associated with the second blockchain; and/or additional message contents; etc.

Additionally, the node can execute similar methods and techniques described above to generate and configure the transaction to: trigger the message object to generate an announcement specifying an object identifier of an unlocker object—associated with an unlocker puzzle specified in the message object—in the set of blockchain objects; to spend a set of vault objects based on the first amount of the first asset associated with the first blockchain and/or the second amount of the second asset associated with the second blockchain; trigger the unlocker puzzle to generate a token object, in the set of blockchain objects, in response to detecting of the announcement. The node can generate and configure the transaction to spend the message object—and thereby remove the message object from the set of blockchain objects—to trigger the message object to generate the announcement.

More specifically, the node can generate and configure the transaction to: access (or select) the set of vault objects representing a third amount of first asset—corresponding to (or exceeding) the first amount of the first asset and/or the second amount of the second asset—associated with the first blockchain; spend the set of vault objects, and thereby remove the set of vault objects from the set of blockchain objects; and generate a token object characterized by the third amount of first asset in response to spending the set of vault objects.

For example, the node can generate and configure the transaction to access the set of vault objects including: a first vault object associated with a first signature and representing a fourth amount of the first asset associated with the first blockchain; and a second vault object associated with a second signature and representing a fifth amount of the first asset associated with the first blockchain.

In this example, the node can generate and configure the transaction to: spend the first vault object and the second vault object (and thereby remove the first vault object and the second vault object from the set of blockchain objects); spend a security object associated with a third signature; and generate the token object, in the set of blockchain objects, based on the fourth amount of the first asset and the fifth amount of the first asset. In particular, the second amount of the second asset can correspond to a combination (e.g., a sum) of the fourth amount of the first asset and the fifth amount of the first asset. The node can generate the transaction including an aggregate signature based on the first signature, the second signature, and the third signature.

In this implementation, in Step S140, the node executes the foregoing methods and techniques to transmit the transaction to the first distributed network associated with the first blockchain for commitment in a block in the first blockchain.

Accordingly, the computer system can: retire the token from the second blockchain; and transfer value associated with the token (e.g., the third amount of the first asset associated with the first blockchain) to the destination address associated with the first blockchain.

### 8. Multiple Message Object Spends

In one implementation, the computer system: accesses a mempool of the first distributed network; and detects a subset of pending transactions in the mempool and associated with the portal object, a set of message objects, and/or a set of messages. Each transaction in the subset of pending transactions is configured to spend the portal object to trigger the portal object to generate a subset of message objects, in the set of message objects, representing a subset of messages in the set of messages.

More specifically, each transaction in the subset of pending transactions can specify a list of the subset of messages.

In this implementation, the computer system: generates a new transaction—specifying a list of the set of messages (e.g., an aggregation of subsets of messages represented in the subset of pending transactions)—configured to spend the portal object, which triggers the portal object to generate the set of message objects; and replaces the subset of pending transactions in the mempool with the new transaction.

For example, the computer system can: add the new transaction to the mempool; and remove the subset of pending transactions from the mempool.

Therefore, the computer system can combine multiple transactions configured to spend the portal object into a single transaction, thereby enabling the computer system to relay multiple messages—associated with (and transparent to) multiple users associated with these messages—from the second blockchain to the first blockchain in a single block of the first blockchain.

### 9. Bridge Protocol Update

Generally, the set of validator nodes associated with the first blockchain can modify the first bridge (e.g., a puzzle of the portal singleton, membership of the set of validator nodes).

In one implementation, a validator node: accesses a set of signatures based on private keys (e.g., “cold” keys stored in hardware secure devices associated with the set of validator nodes) associated with the set of validator nodes; and generates a transaction configured to modify the first bridge based on the set of signatures.

More specifically, the validator node can generate the transaction: including the set of signatures; and configured to modify the first bridge in response to a quantity of signatures in the set of signatures exceeding a threshold quantity of signatures.

### 10. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for communicating data between a first blockchain and a second blockchain, the method comprising, at a node:
accessing a first message identifier for a first message associated with the second blockchain;
accessing a set of signatures representing detection of the first message in a first block in the second blockchain by validator nodes in a set of validator nodes for the first blockchain, the first message containing a representation of the first message identifier;
generating a first transaction:
comprising the set of signatures; and
configured to:
in response to detecting the set of signatures, trigger a first portal object to generate a first message object, in a set of blockchain objects associated with the first blockchain, representing the first message;
remove the first portal object from the set of blockchain objects; and
generate a second portal object, in the set of blockchain objects, based on the first portal object; and
transmitting the first transaction to a distributed network associated with the first blockchain for commitment in a second block in the first blockchain.

2. The method of claim 1, wherein generating the first transaction comprises generating the first transaction configured to:
trigger the first portal object to generate the first message object representing the first message, the first message representing generation of a token object associated with the first blockchain;
trigger the first message object to generate an announcement specifying an object identifier of the token object;
remove the first message object from the set of blockchain objects; and
generate the token object in the set of blockchain objects in response to detection of the announcement, the token object characterized by the object identifier.

3. The method of claim 2, wherein generating the first transaction comprises generating the first transaction configured to:
trigger the first portal object to generate the first message object characterized by a parent identifier associated with the first portal object;
trigger the first message object to generate an assertion representing the parent identifier associated with the first portal object; and
generate the token object in the set of blockchain objects in response to detection of the assertion.

4. The method of claim 2, wherein generating the first transaction comprises generating the first transaction configured to:
spend a first token object in response to detection of the announcement;
trigger a security object, in the set of blockchain objects, to generate an assertion representing a spend of the first token object; and
generate the token object comprising a second token object in response to the assertion, the second token object characterized by a parent identifier associated with the first token object.

5. The method of claim 2, further comprising:
generating a second transaction configured to:
trigger a token burner puzzle associated with the token object to generate a second message object in the set of blockchain objects, the second message object:
representing a second message for the second blockchain, the second message representing retirement of the token object from the first blockchain; and
characterized by a destination address associated with the second blockchain; and
remove the second message object from the set of blockchain objects by spending the second message object;
transmitting the second transaction to the distributed network associated with the first blockchain for commitment in a third block in the first blockchain.

6. The method of claim 1, wherein generating the first transaction comprises generating the first transaction configured to:
trigger the first portal object to generate the first message object representing the first message, the first message representing retirement of a token associated with the second blockchain, the token characterized by a second amount of a second asset associated with the second blockchain; and
trigger the first message object to generate an announcement specifying an object identifier of an unlocker object in the set of blockchain objects;
remove the first message object from the set of blockchain objects;
remove a first vault object from the set of blockchain objects, the first vault object characterized by a first amount of a first asset associated with the first blockchain; and
generate a token object in the set of blockchain objects in response to detection of the announcement, the token object characterized by a third amount of the first asset based on:
the first amount of the first asset; and
the second amount of the second asset.

7. The method of claim 6, wherein generating the first transaction comprises generating the first transaction configured to trigger the unlocker object to:
remove the first vault object from the set of blockchain objects; and
generate the token object in the set of blockchain objects in response to detection of the announcement.

8. The method of claim 6, wherein generating the first transaction comprises generating the first transaction:
configured to spend the first vault object associated with a first signature;
configured to spend a security object associated with a second signature; and
comprising an aggregated signature based on the first signature and the second signature.

9. The method of claim 6:
wherein transmitting the first transaction comprises, during a first time period, transmitting the first transaction to the distributed network associated with the first blockchain; and
further comprising, during a second time period preceding the first time period:
generating a second transaction configured to:
generate the first vault object in the set of blockchain objects;
trigger a locker object in the set of blockchain objects to generate an assertion representing the first vault object characterized by the first amount of the first asset; and
trigger the locker object to generate a second message object representing a second message in response to the assertion, the second message representing generation of the token associated with the second blockchain; and
transmitting the second transaction to the distributed network associated with the first blockchain for commitment in a third block in the first blockchain.

10. The method of claim 1:
wherein generating the first transaction comprises generating the first transaction configured to trigger the first portal object to generate the first message object specifying a target puzzle hash;
further comprising:
generating a second transaction configured to trigger the first message object to generate an announcement for a target blockchain object associated with the target puzzle hash; and
transmitting the second transaction to the distributed network associated with the first blockchain for commitment in a third block in the first blockchain.

11. The method of claim 10, wherein generating the second transaction comprises generating the second transaction configured to:
remove the first message object from the set of blockchain objects; and
trigger the target blockchain object to generate a token object in the set of blockchain objects in response to the announcement.

12. The method of claim 1, wherein generating the first transaction comprises generating the first transaction configured to:
remove the first portal object from the set of blockchain objects, the first portal object characterized by:
a first parent identifier; and
a first puzzle hash representing a first puzzle; and
generate the second portal object characterized by:
a second parent identifier associated with the first portal object; and
a second puzzle hash representing a second puzzle based on the first puzzle.

13. The method of claim 1, wherein generating the first transaction comprises generating the first transaction configured to:
remove the first portal object from the set of blockchain objects, the first portal object characterized by a first puzzle hash representing a first puzzle; and
generate the second portal object characterized by a second puzzle hash representing a second puzzle based on the first puzzle and the first message identifier.

14. The method of claim 1, wherein generating the first transaction comprises generating the first transaction configured to trigger the first portal object to:
calculate a quantity of signatures in the set of signatures; and
generate the first message object representing the first message in response to detecting the quantity of signatures, in the set of signatures, exceeding a threshold quantity.

15. The method of claim 1:
wherein accessing the set of signatures comprises accessing the set of signatures from a set of communication relays associated with the set of validators, the set of signatures characterized by a quantity of signatures in the set of signatures; and
wherein generating the first transaction comprises generating the first transaction in response to detecting the quantity of signatures, in the set of signatures, exceeding a threshold quantity.

16. A method for communicating data between a first blockchain and a second blockchain, the method comprising, at a node:
accessing a message identifier for a message associated with the second blockchain, the message representing generation of a token object associated with the first blockchain;
accessing a set of signatures representing detection of the message in a first block in the second blockchain by validator nodes in a set of validator nodes for the first blockchain, the message containing a representation of the message identifier;
generating a first transaction:
comprising the set of signatures; and
configured to:
in response to detecting the set of signatures, trigger a first portal object to generate a message object, in a set of blockchain objects associated with the first blockchain, representing the message;
trigger the message object to generate an announcement; and
generate the token object in the set of blockchain objects in response to detection of the announcement; and
transmitting the first transaction to a distributed network associated with the first blockchain for commitment in a second block in the first blockchain.

17. The method of claim 16, wherein generating the first transaction comprises generating the first transaction configured to:
trigger the first portal object to generate the message object characterized by a parent identifier associated with the first portal object;
trigger the message object to generate an assertion representing the parent identifier associated with the first portal object; and
generate the token object in the set of blockchain objects in response to detection of the assertion.

18. The method of claim 16, wherein generating the first transaction comprises generating the first transaction configured to:
remove the first portal object from the set of blockchain objects, the first portal object characterized by a first puzzle hash representing a first puzzle; and
generate a second portal object, in the set of blockchain objects, characterized by a second puzzle hash representing a second puzzle based on the first puzzle and the message identifier.

19. A method for communicating data between a first blockchain and a second blockchain, the method comprising, at a node during a first time period:
accessing a message identifier for a first message associated with the second blockchain, the first message representing retirement of a token associated with the second blockchain, the token characterized by a second amount of a second asset associated with the second blockchain;
accessing a set of signatures representing detection of the first message in a first block in the second blockchain by validator nodes in a set of validator nodes for the first blockchain, the first message containing a representation of the message identifier;
generating a first transaction:
comprising the set of signatures; and
configured to:
in response to detecting the set of signatures, trigger a first portal object to generate a first message object, in a set of blockchain objects associated with the first blockchain, representing the first message;
trigger the first message object to generate an announcement;
remove a first vault object from the set of blockchain objects, the first vault object characterized by a first amount of a first asset associated with the first blockchain; and
generate a token object in the set of blockchain objects in response to detection of the announcement, the token object characterized by a third amount of the first asset based on:
the first amount of the first asset; and
the second amount of the second asset; and
transmitting the first transaction to a distributed network associated with the first blockchain for commitment in a second block in the first blockchain.

20. The method of claim 19, further comprising, during a second time period preceding the first time period:
generating a second transaction configured to:
generate the first vault object in the set of blockchain objects;
trigger a locker object in the set of blockchain objects to generate an assertion representing the first vault object characterized by the first amount of the first asset; and
trigger the locker object to generate a second message object representing a second message in response to the assertion, the second message representing generation of the token associated with the second blockchain; and
transmitting the second transaction to the distributed network associated with the first blockchain for commitment in a third block in the first blockchain.
